(19) United States
(12) Patent Application Publication
(10) Pub. No.: US 2007/0298393 A1
(43) Pub. Date: Dec. 27, 2007

(54) Prasanti-loka

(76) Inventor: Maheswar R. Mikkilineni, Washington, DC (US)

Correspondence Address: STEPHEN CHRISTOPHER SWIFT;SWIFT LAW OFFICE, SUITE 600, 1800 DIAGONAL ROAD, ALEXANDRIA, VA, 22314-2840, US

(21) Appl. No.: 11/449,519

(22) Filed: Jun. 8, 2006

(51) Int. Cl. G09B 19/00

(52) U.S. Cl. 434/236

(57) ABSTRACT

A method to induce sleep, including two steps in its first preferred embodiment: 1. Emptying the mind to prepare for a sleep cycle by calmly concentrating on one thought (which can be any thought). 2. Splitting the mind to activate the master clock to induce a sleep cycle by calmly concentrating on two or more thoughts (which can be any thoughts) . The present invention in its second preferred embodiment is a method of teaching the first embodiment.

### BACKGROUND OF THE INVENTION

1. Field of the Invention

The present invention relates to methods for going to sleep and methods for training people to go to sleep, without the use of pills, drugs or apparatus.

2. Background Information

The brain is the control center of the body. It controls senses, thoughts, memory speech and movement. Survival depends on a properly functioning of brain to regulate the functions of the organs, so that the heart pumps blood, the lungs breath air, and the digestive system assimilates food. the brain requires a sleep-cycle (including deep sleep, and light sleep having portions with rapid eye movement or “REM”, and portions without rapid eye movement or “NREM”) of about eight hours in a 24-hour cycle to function properly.

The 2002 National Sleep Foundation (“NSF”) Sleep in America poll found that 74% of American adults are experiencing a sleeping problem a few night a week or more, 39% get less than seven hours of sleep each weeknight, and more than one in three (37%) are so sleepy during the day that it interferes with daily activities. In the past century, we have reduced our average time in sleep. Thouah our society has changed, our brains and bodies have not. Sleep deprivation is affecting us all and we are paying the price. The pattern of waking during the day when it is light and sleeping at night when it is dark is a natural part of human life. Only recently have scientists begun to understand the alternating cycle of sleep and waking, and how it is related to daylight and darkness.

A key factor in how human sleep is reaulated is exposure to light or to darkness. Exposure to light stimulates a nerve pathway from the retina in the eye to an area in the brain called the hypothalamus. There, a special center called the supra-chiasmatic nucleus (“SCN”) initiates signals to other parts of the brain that control hormones, body temperature and other functions that play a role in making us feel sleepy or wide awake.

The SON works like a master-clock that sets off a regulated pattern of activities that affect the entire body. Once exposed to the first light each day, the clock in the SCN begins performing functions like raising body temperature and releasing stimulating hormones like cortisol. The SON also delays the release of other hormones like melatonin, which is associated with sleep onset, until many hours later when darkness returns.

Melatonin is a natural hormone made by the human body's pineal gland, which is a pea-sized gland located lust above the middle of the brain. During the day the pineal gland is inactive. When the sun goes down and darkness occurs, the pineal is “turned on” by the SCN and begins to actively produce melatonin, which is released into the blood. As a result, sleep becomes more inviting.

Melatonin levels in the blood stay elevated for about 12 hours—all through the night—before the light of a new day when they fall back to low daytime levels. Besides adiusting the timing of the body's clock, bright light has another effect. It directly inhibits the release of melatonin.

The amount of melatonin released at night varies among individuals, and is somewhat related to age. Children on average secrete more melatonin than adults, which decreases further with age.

Currently, there are several prescription drugs available to aid sleep. They can shorten the time it takes to fall asleep and reduce awakenings, which adds to total time spent asleep. Possible side effects include feeling tired or drowsy the next day, memory loss and problems with performance. Prescription sleeping pills can cause strange and potentially dangerous side effects. Those side effects can include danoerous allergic reactions and bizarre behaviors such as “sleep-driving,” in which a person will drive a car while not fully awake and have no memory of doing so.

Circadian rhythms are reaular changes in mental and physical characteristics that occur in the course of a day (circadian is Latin for “around a day”). Most circadian rhythms are controlled by the body's biological “masterclock.” This masterclock, called the suprachiasmatic nucleus (“SCN”), is actually a pair of pinhead-sized brain structures that together contain about 20,000 neurons. The SCN rests in a Part of the brain called the hypothalamus, lust above the point where the optic nerves cross. Light that reaches photoreceptors in the retina (a tissue at the back of the eve) creates signals that travel along the optic nerve to the SON. signals from the SCN travel to several brain regions, including the pineal gland, which responds to light-induced signals by switching off production of the hormone melatonin. The body's level of melatonin normally increases after darkness falls, making a person feel drowsy. The SCN also governs functions that are synchronized with the sleep/wake cycle, including body temperature, hormone secretion, urine production, and chances in blood pressure. Because sunlight or other bright lights can reset the SCN, our biological cycles normally follow the 24-hour cycle of the sun. Disruptions in circadian rhythms increase the risk of heart problems, digestive disturbances, and emotional and mental problems, all of which may be related to their sleeping problems.

Many people with total blindness experience life-long sleeping problems because their retinas are unable to detect light. These people have a kind of periodic insomnia because their circadian rhythms follow their innate cycle rather than a 24-hour one. Daily supplements of melatonin may improve night-time sleep for such patients. However, since the high doses of melatonin found in most supplements can build up in the body, long-term use of this substance may create new problems. But the potential side effects of melatonin supplements are still largely unknown.

Sleep and sleep-related problems play a role in a large number of human disorders. For example, problems such as strokes and asthma attacks tend to occur more frequently during the night and early morning, perhaps due to changes in hormones, heart rate, and other characteristics associated with sleep. Sleep also affects some kinds of epilepsy in complex ways. Sleep deprivation also triggers seizures in people with some types of epilepsy.

Neurons that control sleep interact closely with the immune system. Sleep may help the body conserve energy and other resources that the immune system needs to mount an attack. Sleep problems occur in almost all people with mental disorders, including those with depression and schizophrenia. People with depression, for example, often awaken in the early hours of the morning and find themselves unable to oet back to sleep. The amount of sleep a person gets also strongly influences the symptoms of mental disorders. Extreme sleep deprivation can lead to a seemingly psychotic state of paranoia and hallucinations in otherwise healthy people, and disrupted sleep can trigger episodes of mania (agitation and hyperactivity) in people with manic depression.

Sleep problems are common in many other disorders as well, including Alzheimer's disease, stroke, cancer, and head iniury. These sleep problems may arise from changes in the brain regions and neurotransmitters that control sleep, or from the drugs used to control symptoms of other disorders. Once sleep problems develop, they can add to a person's impairment and cause confusion, frustration, or depression. Patients who are unable to sleep also notice pain more and may increase their reguests for pain medication. Better management of sleep problems in people who have other disorders could improve these patients' health and quality of life.

3. Description of the Prior Art

U.S. Pat. No. 5,318,503, issued on Jun. 7, 1994, to Robert F. Lord, discloses a method and apparatus for auditory and olfactory relaxation, using a headset that both generates sound and diffuses fragrance. The present invention is distinguishable, in that it reguires no apparatus, and it induces sleep rather than merely relaxation.

U.S. Pat. No. 5,599,274, issued on Feb. 4, 1997, to Nusa Widjaja and Robert W. Fish, discloses a trophotropic response system, which uses both light and sound to relax the user. Again, the present invention is distinguishable, in that it reguires no apparatus, and it induces sleep rather than merely relaxation.

U.S. Pat. No. 6,641,522, issued on Nov. 4, 2003, to Joseph August, discloses an apparatus for prolecting “biophilic” natural landscape scenes.

U.S. Pat. No. 6,641,523, issued on Nov. 4, 2003, to Matthew Ashenden, discloses an apparatus for reducing stress that combines music and words.

None of the above inventions and patents, taken either singly or in combination, is seen to describe the instant invention as claimed to induce sleep.

### SUMMARY OF THE INVENTION

The present invention in its first preferred embodiment is a method to induce sleep, including two steps:
1. Emptying. the mind to prepare for a sleep cycle by calmly concentrating on one thought (which can be any thought).
2. Splitting the mind to activate the master clock to induce a sleep cycle by calmly concentrating on two or more thoughts (which can be any thoughts).

The present invention in its second preferred embodiment is a method of teaching the first embodiment.

Accordingly, it is a principal obiect of the invention to calm the mind and induce sleep in a person who otherwise is unable to go to sleep naturally.

It is another obiect of the invention to alleviate stress and anxiety.

It is a further object of the invention to alleviate mental health problems such as depression and neurodegenerative and neurological disorders.

Still another object of the invention is to alleviate physical health problems, such as high blood pressure, hypertension and hot flashes.

It is an object of the invention to provide improved elements and arrangements thereof in a process for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a flowchart showing the steps performed in the first preferred embodiment of the invention, and taught in the second preferred embodiment of the invention.

### DETAILED DESCRIPTION OF THE PREFERRED EMBODIMENTS

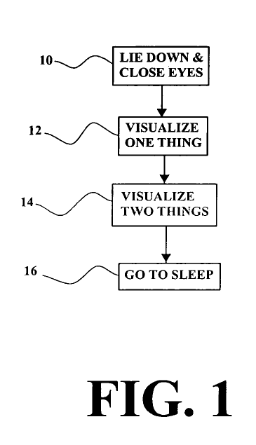

The present invention in its first embodiment is a method for going to sleep, as illustrated by FIG. 1. First, the user of the method lies down (as on a bed or sofa) and closes his or her eves 10. The user then calmly concentrates on one thing (such as by visualizing an obiect, location or action, or any other thing) to empty his or her mind of thoughts and anxiety 12. (This causes the pineal aland to start releasing melatonin into the bloodstream, causing sleepiness.) This decreases activity in the cerebral cortex, and calms the brain stem, thalamus and hypothalamus. The user next calmly concentrates on two (or more) things equallv and simultaneously (such as by visualizing objects, locations or actions, or any other things) 14 while keeping his or her eyes closed, until the cerebrum can no longer communicate between its left and right hemispheres (using the corpus callosum and anterior commissure). Because the brain normally processes only one conscious thouoht at a time, simultaneously processing more than one conscious thought interferes with communication between the two hemispheres of the brain. This results in a split mind with the non-dominant side of the brain turned-off (which is the right hemisphere in right-handed people) and not participating in interpreting visual patterns due to interference created havoc in motor responses of the cerebrum. This causes the brain stem's reticular inhibitory area of the medulla to inhibit the reticular excitatory area, and the activity in the cerebral cortex decrease instantaneously. The acetylcholine system of reticular formation in the brain stem secretes neurotransmitter hormonal agents into the substance of the brain to provide long-period control of activity in specific brain regions. The dopamine system of substantia nigra (near the mesenciphalon) acts as an inhibitory transmitter in basal ganglia and send neurons as the caudate necleus and putamen in the cerebrum, and secretes dopamine to the Hypothalamus and Limbic system in the brain stem.

Thus, the activity in the cerebral cortex, the Thalamus-Hypothalamus and brain stem gets silenced in preparation for a “sleep-state” brain. The serotonin system of raphe nuclei (in the brain stem between the pons-medulla) secretes serotonin, while melatonin is secreted by the pineal gland, and both cause “sleep” in specific brain regions, activating the “master-clock” in the thalamus-hypothalamus and cerebrum to begin the sleep-cycle with deep sleep. The present invention provides a way of increasing these substances without drugs, or importing them from outside the body. REM sleep is probablv caused by norepinephrine between pons-mesencephalon, which generally excites the brain and inhibits a few brain regions or areas. The user then goes to sleep 16, perhaps in seconds.

The second preferred embodiment of the invention comprises training people to practice the first preferred embodiment.

The invention is not the same as what happens in naturally occurring sleep, because an untrained person is not likely to deliberately practice the method of the invention. Using the method to induce sleep by splitting the mind to create havoc in the motor responses in the brain is not a natural process. The invention is not a natural process for those who cannot fall asleep or those who use pills or drugs to get to sleep; their natural process is no longer functional. By using the method of this invention, a person whose natural process of making melatonin and serotonin is no longer active, will be able to reactivate it to induce sleep without pills, drugs, or adverse side effects.

It is to be understood that the present invention is not limited to the embodiments described above, but encompasses any and all embodiments within the scope of the following claims.

1. (canceled)

2. A method to induce sleep, comprising the steps of:
(a) calming the brain by concentrating upon one principal thought; and
(b) activating the brain's master-clock to induce sleep by splitting the mind by concentrating, equally and calmly, upon two or more principal thoughts at the same time.

3. The method to induce sleep according to claim 2, wherein a person using the method closes their eyes at the start of step (a) and keeps them closed through step (b)

4. The method to induce sleep according to claim 2, wherein the one principal thought in step (a) is a visualization of any object.

5. The method to induce sleep according to claim 2, wherein the one principal thought in step (a) is a visualization of any location.

6. The method to induce sleep according to claim 2, wherein the one principal thought in step (a) is a visualization of any action.

7. The method to induce sleep according to claim 2, wherein the principal thoughts in step (b) are all visualizations of any objects.

8. The method to induce sleep according to claim 2, wherein the principal thoughts in step (b) are all visualizations of any locations.

9. The method to induce sleep according to claim 2, wherein the principal thoughts in step (b) are all visualizations of any actions.

10. The method to induce sleep according to claim 2, wherein there are only two principal thoughts in step (b)

11. The method to induce sleep according to claim 2, wherein splitting the mind causes interference created havoc in motor-responses the user's brain that activates the brain's master-clock to induce sleep.

12. A method for training a person to go to sleep, comprising the steps of:
training a person to calm his or her mind by concentrating upon one principal thought; and
training the person to activate his or her brain's master-clock to induce sleep by concentrating, equally and calmly, upon two or more principal thoughts at the same time.

13. The method for training a person to go to sleep according to claim 12, including:
training the person to close their eyes at the start of step (a) and keep them closed through step (b)

14. The method for training a person to go to sleep according to claim 12, wherein the one principal thought in step (a) is a visualization of an object.

15. The method for training a person to go to sleep according to claim 12, wherein the one principal thought in step (a) is a visualization of a location.

16. The method for training a person to go to sleep according to claim 12, wherein the one principal thought in step (a) is a visualization of an action.

17. The method for training a person to go to sleep according to claim 12, wherein the principal thoughts in step (b) are all visualizations of objects.

18. The method for training a person to go to sleep according to claim 12, wherein the principal thoughts in step (b) are all visualizations of locations.

19. The method for training a person to go to sleep according to claim 12, wherein the principal thoughts in step (b) are all visualizations of actions.

20. The method for training a person to go to sleep according to claim 12, wherein there are only two principal thoughts in step (b).

21. The method for training a person to go to sleep according to claim 12, wherein splitting the mind causes interference created havoc in motor-responses the user's brain that activates the brain's masterclock to induce sleep.
